(19) United States
(12) Patent Application Publication
(10) Pub. No.: US 2008/0110065 A1
(43) Pub. Date: May 15, 2008

(54) System and method for ink over laser label marking

(75) Inventors: Ezequiel Mejia, Woodbury, MN (US); Boris Koyrakh, Minneapolis, MN (US)

Correspondence Address: STROOCK & STROOCK & LAVAN LLP, 180 MAIDEN LANE, NEW YORK, NY, 10038, US

(73) Assignee: Digital Angel Corporation

(21) Appl. No.: 11/595,518

(22) Filed: Nov. 10, 2006

(51) Int. Cl. G09F 3/10

(52) U.S. Cl. 40/299.01

(57) ABSTRACT

The present invention relates to laser marked tags and more specifically, to a system and method for ink over laser label marking. A tag is produced by creating a laser marking that effaces the material within the thickness of a tag. Once the material beneath the surface is obliterated, creating a significant laser marking, the laser marking is covered with ink. The ink that is supplied to the laser marking adheres to the carved out portion within the thickness of the tag, that is, below the outer surface of the tag which protects the ink marking from wear and deterioration.

### FIELD OF THE INVENTION

The present invention generally relates to laser marked tags and, more specifically, to a system and a method for ink over laser label marking.

### BACKGROUND INFORMATION

The present invention addresses the field of tagging and marking livestock and the process of producing a tag that is both durable and easy to locate for those tending to livestock. In order to maintain a tracking system for livestock such as cattle, a tagging system has been used in the past wherein a tag made of a synthetic material such as plastic is affixed to an animal's ear or other appendage. This tag contains identifying material about the animal such as a number or other mark that the animal is identified by or identifying information about where the livestock originated (e.g., XYZ Farms). These tags are useful in case the animal is found by someone and to help prevent theft. Additionally, these tags act as a failsafe measure to assure that the animal is the one that it is supposed to be.

The tags that are currently available in the art are deficient in that they are not distinctive enough to be able to be readily seen by the one tending to the cattle and are also prone to weathering or other erosion. Most tags that are currently available are generated in one of three ways either by i) a laser technique which imprints a marking in the tag; ii) an ink technique which marks the identification on the tag in ink or iii) a hotstamping technique wherein a heated foil is applied to stamp the tags. While there are benefits to each method, there are drawbacks as well. For example, the current laser techniques do not allow the tag to be marked with a dark enough imprint that can be seen clearly from a distance by the one tending to the livestock. Rather, the laser marks that are used on such tags consist of faint marks which that are embedded into the tag and may include a combination of parallel lines that are not easily seen by the eye. Conversely, the ink marks and hotstamping are typically darker than the laser marks since they are made in dark ink colors and made thicker or larger than the laser marks themselves. These markings have their own drawbacks however in that they are not as durable as the laser marks since they can be rubbed off, erased or diminished due to environmental conditions and the like. Ink markings are therefore more prone to deterioration over time.

One type of tag that has been manufactured to try and address some of these deficiencies is disclosed in U.S. Pat. No. 6,779,815 to Vandeputte. In the Vandeputte patent, a tag made of synthetic material is disclosed which combines a certain laser marking and ink marking technique. In Vandeputte, the laser marking consists of narrow parallel laser lines formed in a synthetic material tag, and an ink marking that is placed on the surface of such a tag which covers over and obliterates the laser lines. The Vandeputte tag however has certain shortcomings in that the laser marks of the Vandeputte tag are not easily observable in and of themselves and the ink marking that covers the laser mark is primarily only on the surface of the tag thus making it subject to weathering and other erosion. Since the ink is primarily only on the surface of the tag, the ink marking is subject to being prematurely worn off and the underlying laser mark is not sufficiently visible to be easily seen once the surface ink is eroded.

It therefore would be advantageous to have a tag and method for creating such a tag that is both clearly visible from a distance to those tending for the cattle and durable in a manner that if the ink marking that effaces the material is weathered or eroded in some manner, the tag still serves its intended purpose of identifying the animal in an easy to read manner over a longer period of time.

### SUMMARY OF THE INVENTION

In view of the above discussion and the shortcomings in the field of identification tagging the present invention seeks to overcome such shortcomings by creating a tag that is more durable and easy to view. In one embodiment of the present invention a tag is produced by creating a laser marking that effaces the material within the thickness of a tag. Once the material beneath the surface is obliterated, creating a significant laser marking, the laser marking is covered with ink. The ink that is supplied to the laser marking adheres to the carved out portion within the thickness of the tag, that is, below the outer surface of the tag which protects the ink marking from wear and deterioration.

In one embodiment of the present invention, the ink that is introduced into the thickness of the tag over the laser marking is covered over by a second layer of ink that is substantially flush with the surface of the tag. In another embodiment of the present invention, the tag is covered with a polyurethane like substance that protects the ink and laser markings from erosion.

### BRIEF DESCRIPTION OF THE DRAWINGS

FIG. 1 is a top view of a tag according to one embodiment of the present invention;

FIG. 2 is a sectional view of a tag according to one embodiment of the present invention;

FIG. 3 is a flowchart showing a process of creating a tag according to one embodiment of the present invention; and

FIG. 4 is a sectional view of a tag according to one embodiment of the present invention.

### DETAILED DESCRIPTION OF THE PREFERRED EMBODIMENTS

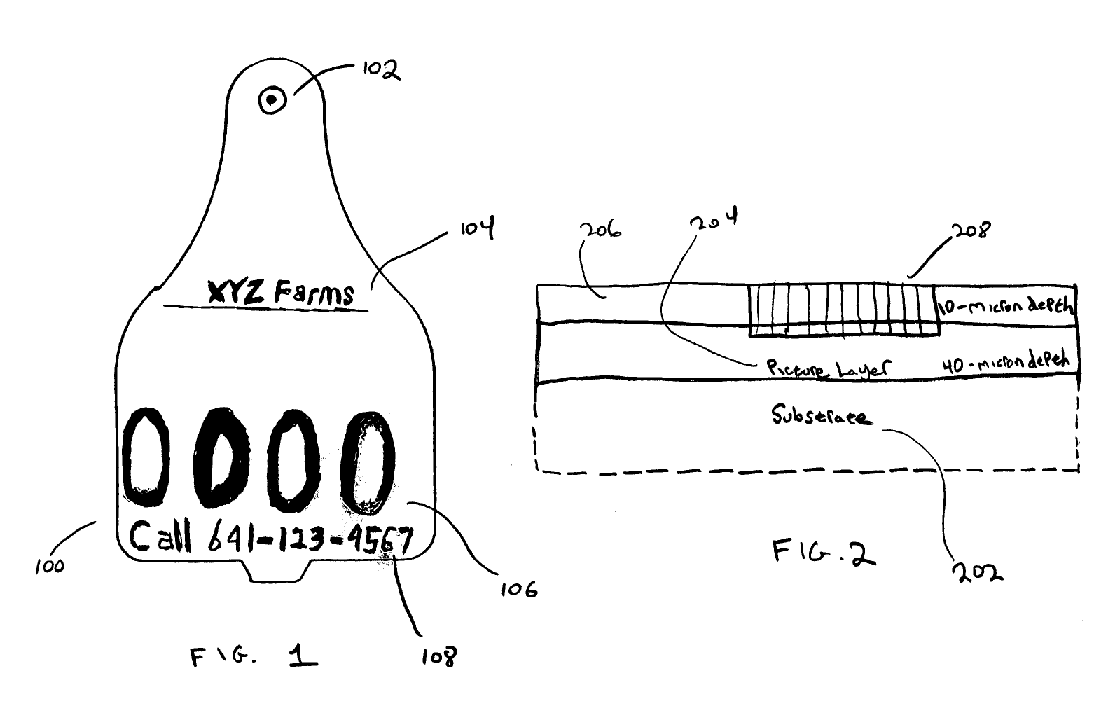

In general, the present invention provides for an ink over laser marked tag that is both durable and easy to view. With reference now to FIGS. 1-4, it will be shown and described several embodiments of improved ink over laser tags, and a method of making the same.

With reference to FIG. 1, it is shown an exemplary tag, which can be used to identify livestock or other intended recipients. The tag is preferably made of a plastic or other synthetic material, which can be engraved upon by a laser and covered over with an ink substance. The tag 100 preferably contains a round circular aperture 102 at the top of the tag, which is used to append the tag to the animal's ear or other appendage. A fastening mechanism is inserted into aperture 102 to append tag 100 to the animal. As is known in the art, the tag 100 can be appended to the livestock by using various staple mechanisms or other fastening methods that enable a connection with aperture 102 to the ear or other appendage or body part of the animal. Once appended to the animal, the tag acts as an identifying marker for the animal similar to the way animals are branded using a branding iron.

It should be appreciated, that although tag 100 is shown in a particular shape and size, the tag can be produced in different shapes and sizes, as a matter of application-specific design choice. For example, for larger livestock, a larger tag may be necessary while smaller animals may require a smaller tag. These tags can be created in circular, square, or rectangular shapes, for example, based on the particular appendage that the tag is being attached to or the need of those tending to the animals.

As can be further seen in FIG. 1, the tag 100 contains identifying information that as will be explained below is lasered onto tag 100 and has been covered over by an ink substance. For instance, inscription 104 can identify the origin of the animal being tagged with tag 100. Identifier 106 can show a particular identifier or number associated with such animal. Contact information 108 can list a telephone number of other contact information that can be used if the animal tagged with the tag 100 is found. It should be noted that information 104, 106 and 108, can take on many different forms, including additional verbiage provided by the user of the tag 100 that can include instructions for a handler of the animal (e.g., what to feed or not feed to a particular animal), instructions for someone who finds the animal (e.g., how to locate the owner), or instructions for an importer of the animal (e.g., origin of the livestock or other related information) and the like.

As can be seen from FIG. 1, the information on tag 100 is clearly visible and easy to read. As will be discussed below, this information is lasered out of tag 100 creating a laser marking that is then covered with an ink substance in a way that makes it durable and easy to read. This laser marking can either be completely covered over by ink or various portions of the laser mark can be covered. For instance, as can be seen in Identifier 106, the ink markings (namely the zeros) although on top of the same laser marked zeros contain various degrees of ink. For instance the first “0” marking covers the laser marking exactly while the next two “0” markings contain differing amounts of ink beyond the inside boundary of the laser marking. Conversely, the last “0” marking contains certain areas on the upper and lower portion of the laser marking that are not covered with ink at all.

It should also be appreciated that with this new method of engraving tags, the information that can be placed on the tag is infinite. This includes the ability to place pictures on the tags or other symbols such as a bar code, which would more easily enable the identification of the animals associated with the tag. It should also be appreciated that although described in terms of animal tagging, the disclosed tags and tagging method can be used for identification of other living and non-living matter for which tags can be created using the below discussed method.

In order to create tag 100, the tag undergoes a laser and inking process that allows it to generate a durable yet easy to distinguish marking. The tag 100 is made of a plastic or other synthetic material that is susceptible to the power of a laser, but yet strong enough to withstand a laser and not disintegrate entirely when subjected to the heat of a laser. Tags of different thickness and size can be used to create tag 100, although the time that will be needed to create the tag and the distinctiveness of the markings on the tag will vary based on the tags size and thickness. In a preferred embodiment, the tag 100 has at least a thickness of 60 microns.

As can be seen in FIG. 2, the depth of tag 100 can be characterized as being divided into three layers. A substrate layer 202, a picture layer 204 and a top layer 206. The substrate layer 202 is the bottom layer and the laser does not reach to that level. Rather the substrate layer serves as the bottom side of the tag which is flat and has no information on it. Picture layer 204 preferably has a depth of 40 microns and is the internal layer wherein the laser carving is performed. The top layer 206 preferably has a depth of 10 microns and it is on this top or surface layer that the additional ink or other coloring or a protective layer that is applied to tag 100 in addition to the ink applied over the laser marking in the picture layer 204, is applied onto.

As with other laser techniques used in other fields, when a laser is applied to tag 100, the heat of the laser burns off the resin that colors the plastic or other synthetic material and exposes the carbon material below the resin. It is this revealing of the carbon that appears as a marking within tag 100 to the naked eye. Depending on how strong the laser is, the resin removed varies and thus the thickness and brightness of the carbon exposed differs as well. The disintegration of the synthetic material creates an indelible marking that corrodes the material and is branded into the tag. In a preferred embodiment, the laser is strong enough to burn off the resin material up until the substrate level 202 and efface the tag 100 to create a vivid marking of whatever lettering, picturing or other symbols is to be imprinted on tag 100. Unlike the laser marking in Vandeputte, the laser marking of the present invention substantially removes the entire surface layer of the specific mark. For example, rather than creating parallel lines depicting the number zero as in Vandeputte, the laser marking of the present invention substantially obliterates the entire number thus creating a recessed portion depicting a specific number. This lasering creates picture layer 204, which appears as a dark marking of that which is to be engraved on the tag. Once the laser mark is created at the picture layer 204 a hard contrast ink image 208 is embedded within the area effaced by the laser created in the picture layer. This ink is applied at the picture level as well and goes below the top surface of the tag. The ink adheres to the exposed carbon in the picture layer creating an ink marking that covers the laser marking initially created within the picture layer 204. The laser marking is distinguished from previously known lasered tags in that the laser technique used herein actually removes the synthetic material in which is created an actual vibrant marking that can then be darkened by the ink covering.

In a preferred embodiment, once the ink image has been placed within the laser etched marking, a top coat of the image can be applied to the top of such laser etched marking at the top layer 206. This process thus creates a laser image at the picture level 204 which is filled with ink and such ink covered laser image is then covered over with an additional layer of ink at the top level 206. This creates a tag 100 that has both the benefits of a laser etched tag as well as an ink covered tag without the drawbacks of either process. Rather, since the laser marking actually corrodes the synthetic material, the laser marking that is covered with ink will make a visible marking that will not easily be affected by the environment over time and that in combination with the top layer that is covered with an additional ink layer makes the marking highly visible and more durable.

In another embodiment, tag 100 can also be top coated with polyurethane or other protective material that will protect the entire tag 100 from deterioration. This polyurethane material or coating is applied to a portion of or to the entire tag to protect the underlying markings from any effect that weathering or other disintegration may have on it.

As can be seen in FIG. 2, inking an additional layer below the surface of tag 100 enables the identification marks applied to the tag 100 to last longer than if they were merely applied to the surface. While in the past, ink over laser technology involved laser etching identification marks within the surface of the synthetic material, the ink has up until this point only been primarily applied to the surface of the tag. This creates the deficiency of allowing the ink to wear off which leaves a faint laser mark below the surface that either does not resemble the inked over mark that had previously existed or at the very best resembles a faint portion of the marking. In contrast, with the current embodiment of the present invention, the ink is applied below the surface of the tag within the laser marking thus making the inked marking more indelible and durable. This is because once the resin is burned away by the laser on picture layer 204, the carbon layer that remains is used as an adherent to which the ink which is applied in a later stage sticks. Thus, unlike a situation where the ink is applied to the surface of the tag, in this situation the ink is actually embedded within the tag making it more visible and more durable. In this situation, therefore, if the ink on the surface is rubbed off or is weathered for whatever reason, the ink below the surface that has adhered to the laser marking still remains in the form that it existed prior to the surface's deterioration.

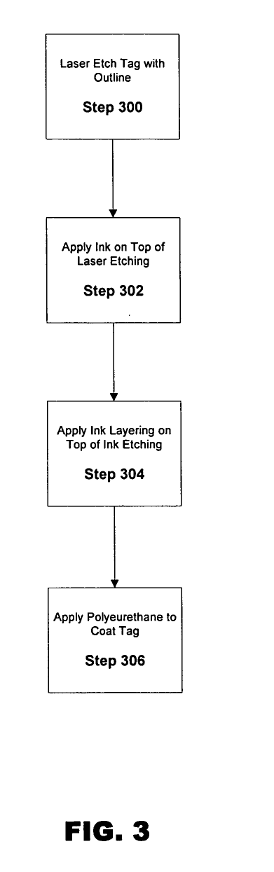

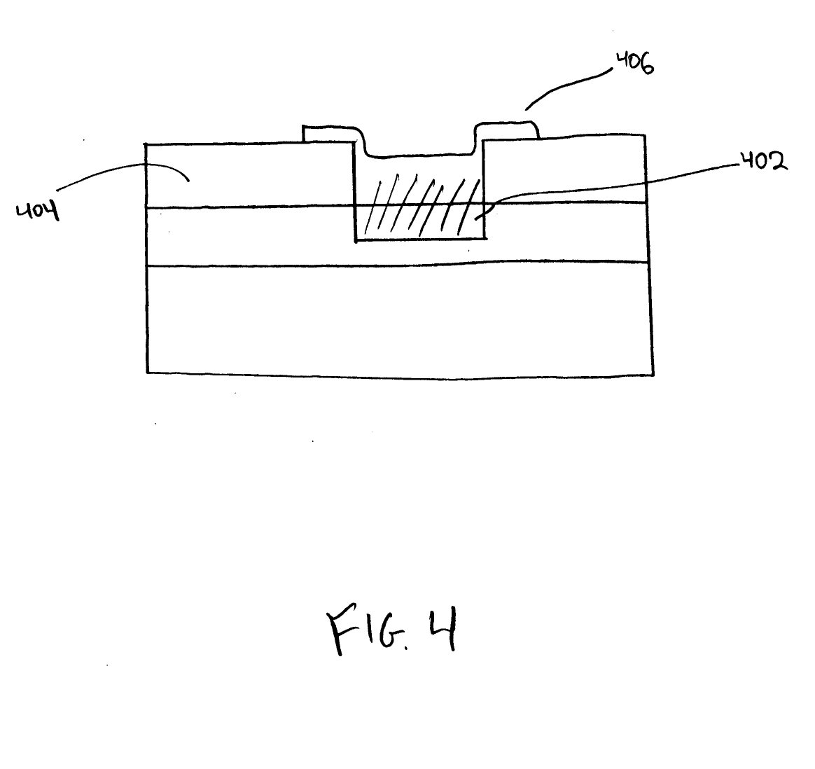

In order to carry out the above discussed process and the preferred embodiment of the present invention, a laser machine is used that has the ability to both provide a lasering of the tag 100 as well as the inking over of the laser marking it has created. Such a machine can carry out each of the steps of the process on numerous tags 100 in an efficient manner. As can be seen in reference to FIG. 3, the process carried out in order to create tag 100 with the layering set forth in reference to FIG. 2 is shown using one or more of the following steps as carried out by a laser machine.

First, one or more blank tag(s) are set forth on a sheet placed under a laser machine. The laser is then activated to create a laser marking within or below the surface of each tag leaving a substrate layer and resulting in an effacing of the synthetic material creating an etching out of the identification material in a picture layer, which is preferably at least 40 microns deep. Step 300.

Once the laser marking has been created from the picture layer, an inking process consisting of the spraying or stamping of a high contrast ink image into the laser marking is applied to the tag. Step 302. This inking process consists of ink being applied in an even or uneven process into the marking created by the laser. It should be noted that the ink applied into the marking of the laser could either be applied i) directly into the laser mark, or in other words into the location where the synthetic material has been blotted out; ii) as an outline around the laser marking; or iii) any combination thereof. The present process is not limited in any way to applying an exact amount of ink to match the laser markings. Rather, the ink that is applied can vary based on specification as to whether all of any of the laser markings are covered by ink or whether an entire different design is created by the ink overlay. For example, the laser markings may generate the numbers 123 while the ink being overlaid may only fill up the number 1 while placing an entire different design over the numbers 2 and 3. This will create somewhat of a double design, consisting of an underlying laser marking that is somewhat covered or filled with ink and a second ink design distinct from the laser design. This may for instance be a fail-safe marking that creates separate marking when the tag is looked at initially while an additional marking is shown if and when the initial ink overlay is removed.

Next, once the ink is applied to the laser marking, an additional layer of ink is preferably applied over the ink etching to the surface of the tag 100 creating an even bolder ink marking. Step 304. This additional inking step, while not necessary to view identification material etched or overlaid onto the tag 100, will give the tag an appearance of making the ink substantially flush with the tag 100 and not making it readily apparent that a laser has been used below. Once again, this is a design choice that can be altered in order to make the tag more useful and aesthetically pleasing to the one caring for the livestock or other user of the tag.

Lastly, in one embodiment polyurethane or other coating material is applied to the entire tag 100 to make the ink layering less perceptible to weathering. Step 306. The amount of coating material applied, if any, is based on the need for the particular owner or user of a tag 100.

As was discussed above, the ink that is placed in the laser marking need not cover the laser marking exactly. Rather, the ink can overflow the laser marking or be spread on the inside of such marking. As can be seen in FIG. 4 for example, a laser marking 402 is created or engraved within a layer 404 of the tag. An ink layer 406 is then applied that goes around and outside of the laser marking. In other words, while the laser marking 402 may create an image of a particular letter or number (e.g., a zero), the ink marking 406 need not exactly trace such laser marking 402 but rather the ink marking 406 can go outside of the laser marking 402.

Those skilled in the art will recognize that the method and system of the present invention has many applications, may be implemented in many manners and, as such is not to be limited by the foregoing exemplary embodiments and examples. In this regard, any number of the features of the different embodiments described herein may be combined into one single embodiment and alternate embodiments having fewer than all of the features are possible. Thus, while there have been shown and described fundamental novel features of the invention as applied to the exemplary embodiments thereof, it will be understood that omissions and substitutions and changes in the form and details of the disclosed invention may be made by those skilled in the art without departing from the spirit of the invention. It is the intention, therefore, to be limited only as indicated by the scope of the claims appended hereto. Moreover, the scope of the present invention covers conventionally known and future developed variations and modifications to the system components described herein as would be understood by those skilled in the art.

1. A method of creating an identification label comprising:
creating a laser marking within a synthetic material;
applying a first ink substance to at least a part of the laser marking;
applying an additional ink substance on the surface of the identification label covering at least a portion of the first ink substance.

2. An identification label comprising:
a synthetic material comprising a top layer, a picture layer and a substrate layer;
a laser marking within the picture layer;
a first ink marking substantially covering the laser marking, said first ink marking being below the top layer; and
a second ink marking on the surface of the identification label.

3. A method of creating an identification label comprising:
creating a laser marking within a synthetic material;
applying a first ink substance, at least a potion of which is outside of the laser marking;
applying an additional ink substance on the surface of the identification label covering at least a portion of the first ink substance.
